(19) United States
(12) Patent Application Publication
(10) Pub. No.: US 2026/0303692 A1
(43) Pub. Date: Oct. 1, 2026

(54) Shared Coordinate System for Extra Reality Copresence

(71) Applicant: Meta Platforms Technologies, LLC, Menlo Park, CA (US)

(72) Inventors: Saurabh KULKARNI, Menlo Park, CA (US); Fangwei LEE, San Carlos, CA (US); Samuel MCGAREY, Mountain View, CA (US)

(21) Appl. No.: 19/092,467

(22) Filed: Mar. 27, 2025

(51) Int. Cl. H04L 67/131; G06T 19/20

(52) U.S. Cl. CPC H04L 67/131; G06T 19/20

(57) ABSTRACT

Aspects of the present disclosure provide a shared coordinate system for extra reality (XR) copresence that selects origin points, within real-world spaces, relative to which virtual content can be placed, that make shared activities more natural and intuitive, while keeping the relative positions for any shared virtual objects intact. For example, the system can select the origin point based on constraints and features defined by, for example, characteristics of the users' physical spaces (e.g., size, layout, furniture, open space, etc.), existing avatars already in the XR environment and their location relative to their existing origin points, requirements of virtual objects (e.g., must be rendered on a wall or tabletop), etc. In some cases, the system can construct a model matching the users' spaces and select respective origin points for content based on locations within the matching areas that meet the defined constraints.

### TECHNICAL FIELD

The present disclosure is directed to providing a shared coordinate system for multiple extra reality (XR) systems accessing a multiuser XR environment from the same or different real-world spaces.

### BACKGROUND

Extra reality (XR) devices are becoming more prevalent. As they become more popular, the applications implemented on such devices are becoming more sophisticated. Mixed reality (MR) and augmented reality (AR) applications can provide interactive three-dimensional (3D) experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. An HMD can have a pass-through display, which allows light from the real-world to pass through a lens to combine with light from a waveguide that simultaneously emits light from a projector in the HMD, allowing the HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an extra reality (XR) environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing a shared coordinate system for XR copresence.

FIG. 6A is a conceptual diagram illustrating an example overhead view of real-world space models for co-present users accessing an XR environment.

FIGS. 6B-6D are a conceptual diagrams illustrating an example overhead views of overlapping real-world space models for copresence amongst users accessing an XR environment.

FIG. 7A is a conceptual diagram illustrating an example view, from a first XR system of a first user, of an XR environment, accessed from a first real-world space, including a virtual object and an avatar representing a second, co-present user accessing the XR environment from a second real-world space.

FIG. 7B is a conceptual diagram illustrating an example view, from a second XR system of a second user, of an XR environment, accessing from a second real-world space, including a virtual object and an avatar representing a first, co-present user accessing the XR environment from a first real-world space.

FIG. 7C is a conceptual diagram illustrating an example view, from a first XR system of a first user, of an XR environment accessed by the first XR system and a second XR system of a second, co-present user, in which a virtual object has been moved relative to a first origin point in the XR environment.

FIG. 7D is a conceptual diagram illustrating an example view, from a second XR system of a second user, of an XR environment accessed by the second XR system and a first XR system of a first, co-present user, in which a virtual object has been moved relative to a second origin point in the XR environment.

FIG. 8 is a conceptual diagram illustrating an exemplary environment for XR copresence in an XR environment.

The techniques introduced here may be better understood by referring to the following Detailed Description in conjunction with the accompanying drawings, in which like reference numerals indicate identical or functionally similar elements.

### DETAILED DESCRIPTION

Often, when a user accesses a multiuser extra reality (XR) environment on an XR system, avatar placement within the XR environment is random. For example, avatars of other users can show up through the user's real-world wall or behind the user, often resulting from aligning room geometries of different co-present users accessing a shared XR experience from different real-world spaces. Aspects of the present disclosure provide an improved XR copresence system that solves the issues based by conventional systems by analyzing a user's physical surroundings and recommending an origin for coordinates for each of the users involved. This results in XR copresence and shared activities that are more natural and intuitive, while keeping the relative positions for any shared virtual content intact. As used herein, “copresence” refers to access of multiple users of the same XR experience from the same and/or different real-world spaces, while users accessing the same XR experience from the same real-world space are exclusively referred to as “co-located.”

Some implementations of the XR copresence system described herein can intelligently select an origin point, for each user within their real-world space, relative to which avatars and virtual objects can be positioned. The origin point can be selected based on constraints and/or features defined by, for example, characteristics of the users' physical spaces (e.g., size, layout, furniture, open space, etc.), existing avatars already in the XR environment and their location relative to their existing origin points, requirements of virtual objects (e.g., must be rendered on a wall or tabletop), etc. In some cases, the XR copresence system can construct a model matching portions of the users' spaces, and select respective origin points based on locations within the matched area that meet the defined constraints or other requirements.

For shared activities to seem more realistic and fuel user interactions, the XR copresence system, according to some implementations, can consider users' physical surroundings, and align virtual objects and avatars within them to make sense spatially. For example, the XR copresence system can align two-dimensional (2D) and three-dimensional (3D) virtual objects around users in shared XR environments such that the spatial frame of reference remains consistent and realistic across each XR system accessing the XR environment. For example, the XR copresence system can place panels and other virtual objects (e.g., virtual game boards) around users such that their relative positions make sense with respect to their local real-world space (in the case of mixed reality) and stay relatively consistent throughout the shared activity.

Further, the XR copresence system can position avatars, corresponding to users accessing the shared activity, in the XR environment to encourage seamless natural interactions. Given a host user's scene (and/or any virtual objects), the XR copresence system can determine useful positions for co-located and remote users to increase realism, improve safety, and enrich user interactions. For users, spatial placement of other users' avatars around them can be consistent with respect to each other, making interactions like fist bumps and high fives possible. In addition, the XR copresence system can synchronize virtual objects and avatars with respect to the users. For example, given XR content around the users, the XR copresence system can enable dynamic position recommendations for rendered avatars and virtual objects to ensure that they stay aligned based on the user's real-world and XR scene, even when the location or scene changes.

For example, for co-watching and co-workout XR experiences between users who have different room geometries, the XR copresence system can determine useful positions for their respective friends' avatars to align against their physical spaces to make the activity seamless and fulfilling, while keeping their relative positioning consistent. Thus, a first user can see a second, co-present user in an equal and opposite position to the way the first user is perceived by the second user. This can hold true even if the first user decides to switch rooms or move to the couch. The second user's avatar will stay networked to the first user and the media content, such that it continues to be well positioned with respect to the first user.

The XR copresence system can enable such functionality by using scene data corresponding to real-world spaces from which co-present users are accessing a shared XR environment. From the obtained scene data, the XR copresence system can determine an area in each real-world space that meets constraints required for each real-world space, as well as matches at least a minimum set of features of other real-world spaces (such as is defined by the XR application or XR system). Based on this determined area, the XR copresence system can select origin points for each of the real-world spaces as a reference point for positioning virtual content in each respective space, whereby content is positioned consistently relative to each origin point regardless of the location of the origin point in the respective space.

Embodiments of the disclosed technology may include or be implemented in conjunction with an extra reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Extra reality content may include completely generated content or generated content combined with captured content (e.g., real-world photographs). The extra reality content may include video, audio, haptic feedback, or some combination thereof, any of which may be presented in a single channel or in multiple channels (such as stereo video that produces a three-dimensional effect to the viewer). Additionally, in some embodiments, extra reality may be associated with applications, products, accessories, services, or some combination thereof, that are, e.g., used to create content in an extra reality and/or used in (e.g., perform activities in) an extra reality. The extra reality system that provides the extra reality content may be implemented on various platforms, including a head-mounted display (HMD) connected to a host computer system, a standalone HMD, a mobile device or computing system, a “cave” environment or other projection system, or any other hardware platform capable of providing extra reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the field of XR copresence. Conventional XR systems take a simplistic approach to copresence of users in a multiuser XR environment, and align users around a virtual object (e.g., a virtual table) that may or may not fit within the user's real-world surroundings. The resulting XR environment can result in poor spatial placing, such as misaligned avatars, lack of accessibility and moveability of virtual objects by users, misplaced virtual objects, collision risk with physical objects, etc., which can lower the overall user experience. The XR copresence system described herein can align two or more users (and/or virtual objects) within physical and virtual spaces to make shared activities more natural and enjoyable. The XR copresence system can account for diverse physical room geometries, virtual object dimensions, and user preferences to align avatars and virtual content in a manner that makes sense spatially during shared activities to bring the experience as close to reality as possible, while minimizing collision risk of users with physical objects, and simplifying the complexity of managing co-present XR experiences.

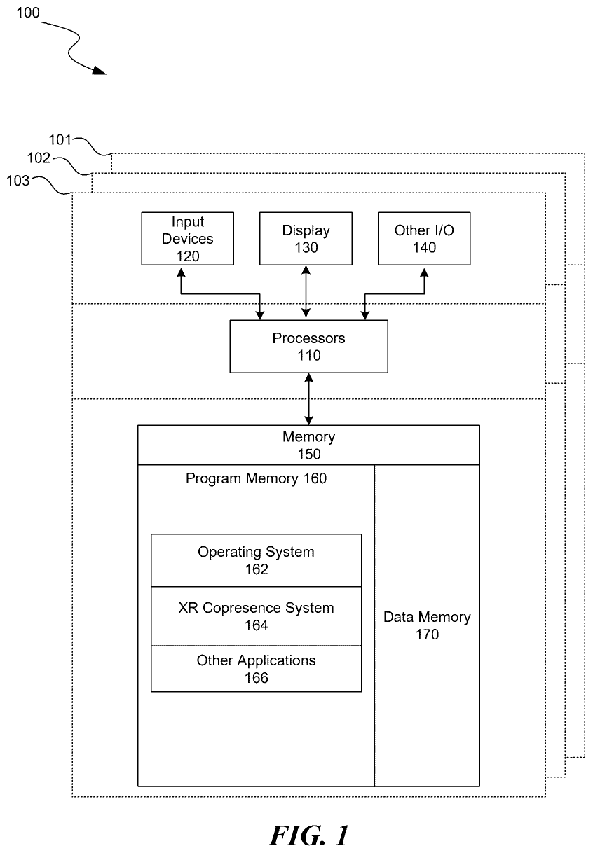

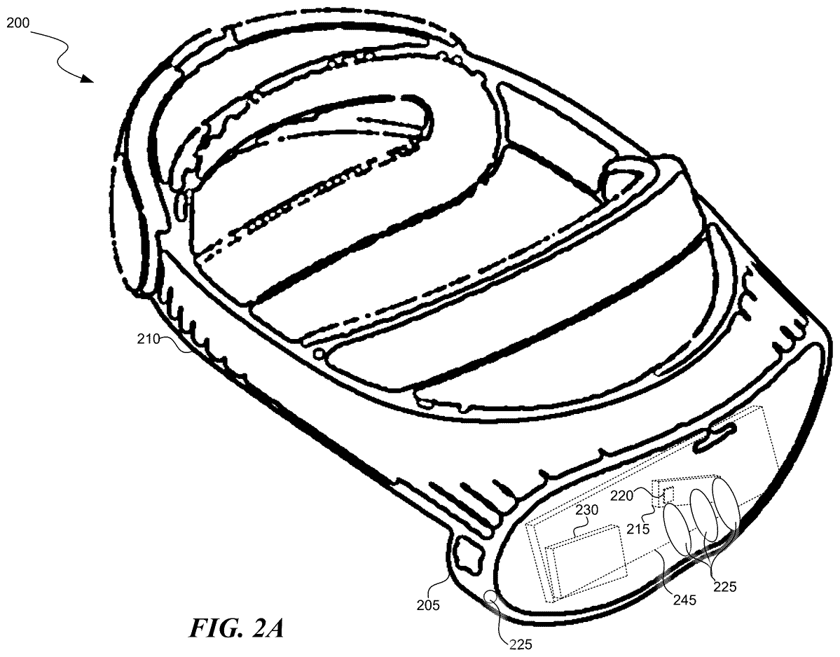

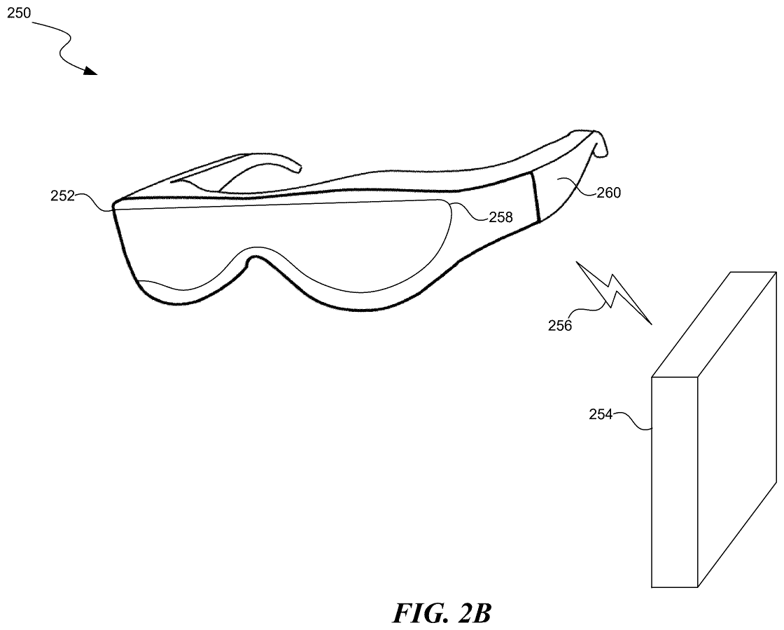

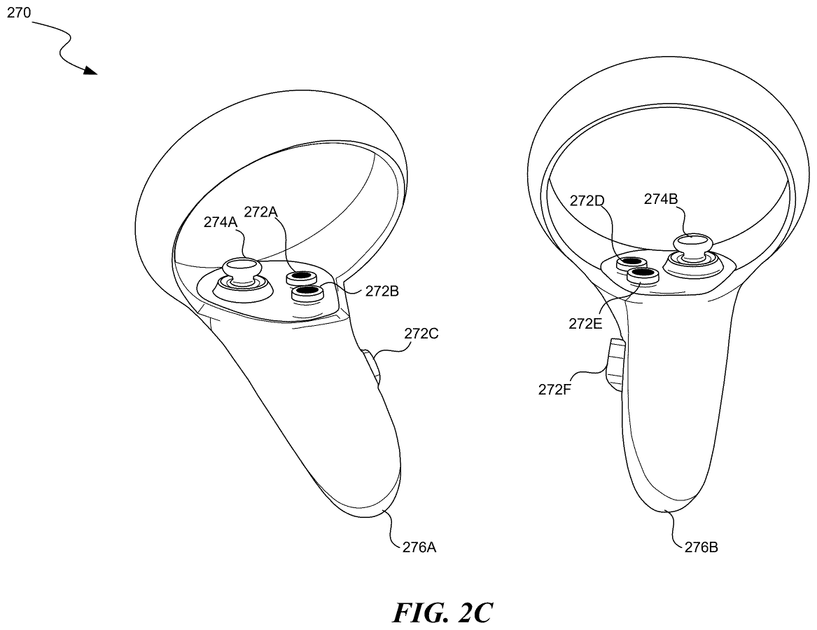

Several implementations are discussed below in more detail in reference to the figures. FIG. 1 is a block diagram illustrating an overview of devices on which some implementations of the disclosed technology can operate. The devices can comprise hardware components of a computing system 100 that can provide a shared coordinate system for extra reality (XR) copresence. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, XR copresence system 164, and other application programs 166. Memory 150 can also include data memory 170 that can include, e.g., scene data, real-world space data, constraint data, feature data, origin point data, virtual object data, rendering data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an extra reality environment in three degrees of freedom (3 DoF) or six degrees of freedom (6 DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3 DoF or 6 DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an extra reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3 DoF or 6 DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

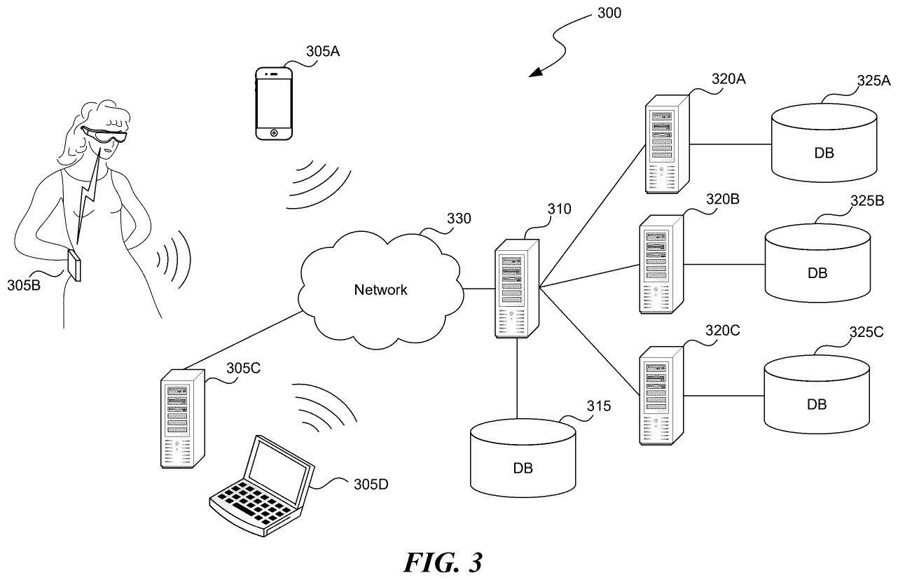

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

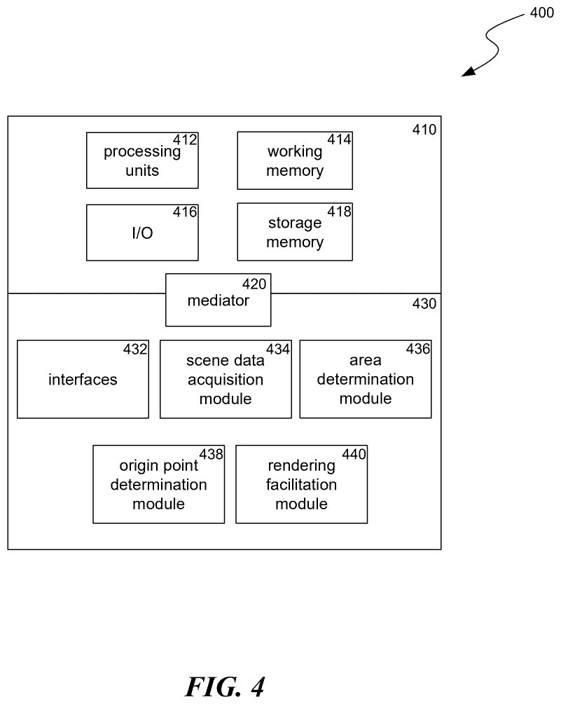

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for providing a shared coordinate system for extra reality (XR) copresence. Specialized components 430 can include scene data acquisition module 434, area determination module 436, origin point determination module 438, rendering facilitation module 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

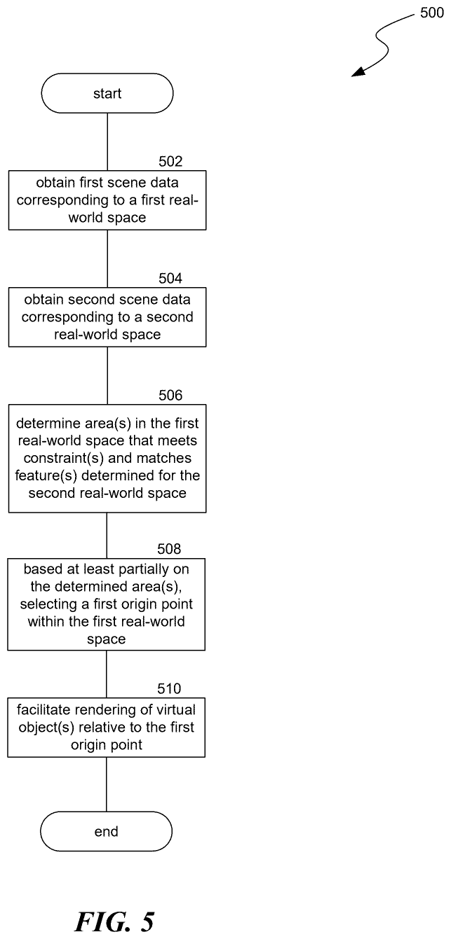

Scene data acquisition module 434 can obtain scene data corresponding to real-world space(s) surrounding XR system(s) that are accessing, or requesting to access, a shared XR experience (e.g., an XR application, an XR environment, etc.). In some implementations, scene data acquisition module 434 can generate the scene data by storing object data associated with one or more physical objects in the real-world scene, with reference to locations in the scene (e.g., associated with one or more spatial anchors establishing frames of reference for the real-world space). The one or more physical objects can have an identified object type. In some implementations, the physical objects can be immoveable, i.e., semi-permanent, such as doorways, walls, ceiling, floor, windows, cabinets, painting, posters, shelves, etc. (and can have corresponding type designations). However, in some implementations, it is contemplated that the physical objects can include moveable objects, such as a desk, a wardrobe, a table, a plant, a lamp, a screen, pen, phone, wallet, keys, etc. (and can have corresponding type designations). In some implementations, scene data acquisition module 434 can obtain the scene data from a separate XR system than that generating the scene data, and/or can obtain scene data from a remote or central computing system (e.g., a platform computing system managing scene data for multiple real-world spaces). Further details regarding obtaining scene data corresponding to real-world space(s) surrounding XR system(s) are described herein with respect to blocks 502 and 504 of FIG. 5.

Area determination module 436 can determine at least one area, based on the scene data and in a real-world space, that A) meets one or more constraints and B) matches at least a minimum set of features determined for a portion of other real-world space(s) of other XR system(s) accessing, or requesting to access, a shared XR experience. The constraint(s) can include any requirements needed (or preferred) in an XR system's local real-world space for rendering the shared XR experience, while the feature(s) can include matched requirements between the XR system's local real-world space and remote real-world space(s) corresponding to other XR system(s) accessing, or requesting to access, the shared XR experience. For example, the constraint(s) and/or feature(s) can include a minimum amount of open floor space in the real-world space(s), particular physical objects in the real-world space(s) (e.g., a tabletop or other furniture), rendering requirements provided by an XR application or the XR system, location(s) of user(s) within their respective real-world spaces, location(s) of avatars within the XR environment, amount of user movement required by the shared XR experience (e.g., an XR experience requiring a large amount of user movement may require a greater amount of open floor area, a less amount of obstacles, etc.), safety requirements, etc. Further details regarding determining area(s), based on scene data and in a real-world environment, that A) meet constraint(s) and B) match feature(s) determined for portion(s) of other real-world space(s), are described herein with respect to block 506 of FIG. 5.

Origin point determination module 438 can, based at least partially on the area(s) determined by area determination module 436, select an origin point within a real-world space for the shared XR experience. The origin point can be an (x=0, y=0, z=0) point in a coordinate system shared amongst the XR systems accessing the shared XR experience from which virtual content can be consistently positioned. For example, a first user's avatar, as viewed on a second user's XR system, can be positioned at an equal and opposite position and orientation as the second user's avatar as viewed on the first user's XR system. In some implementations, origin point determination module 438 can select the origin point at a default position within the determined area(s) (e.g., a central position within open floor space, on a table, etc.). In some implementations, however, origin point determination module 438 can select the origin point corresponding to a feature of the real-world space within the determined area(s) (e.g., a particular physical object). Further details regarding selecting origin point(s) for XR system(s) within real-world space(s) and for an XR environment are described herein with respect to block 508 of FIG. 5.

Rendering facilitation module 440 can facilitate rendering of virtual object(s), in the shared XR experience, at a same position and orientation relative to the origin point determined by origin point determination module 438 as relative to other origin point(s) on other XR system(s) accessing the shared XR experience. Rendering facilitation module 440 can “facilitate rendering” by rendering the virtual object(s) on the XR system, providing rendering data for the XR system, and/or otherwise causing the XR system to render the virtual object(s). Further details regarding facilitating rendering of virtual object(s) in an XR environment relative to an origin point are described herein with respect to block 510 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for providing a shared coordinate system for extra reality (XR) copresence. In some implementations, process 500 can be at least partially performed by an XR system (e.g., a “first XR system”) including one or more XR devices, such as an XR head-mounted display (HMD) (e.g., XR HMD 200 of FIG. 2A and/or XR HMD 252 of FIG. 2B), one or more external processing components, one or more controllers (e.g., controllers 276A and/or 276B of FIG. 2C), etc. In some implementations, one or more blocks of process 500 can be at least partially performed by a server or computing system remote from the XR system, such as a cloud computing system or edge computing system associated with a platform of the XR system. In some implementations, process 500 can be performed by XR copresence system 164 of FIG. 1 and/or components 400 of FIG. 4. In some implementations, process 500 can be performed upon launch, access, or request to access a multiuser XR environment, e.g., a multiuser XR application, on an XR system.

At block 502, process 500 can obtain first scene data corresponding to a first real-world space surrounding a first XR system. In some implementations, upon accessing the first real-world space, the first XR system can define scene data. In some cases, the first XR system can define the scene data by capturing one or more images of the scene, e.g., with cameras integral with or in operable communication with the first XR system and identify objects that have types matching types in a scene lexicon. In other implementations, a user can manually specify a location and a corresponding object type from the scene lexicon. Thus, the first XR system can identify one or more object types (e.g., walls, doors, windows, tables, chairs, floor, ceiling, etc.) of a set of object types defined as scene components, each object type corresponding to a physical object in the one or more images of the scene. The first XR system can generate object data associated with the one or more physical objects having the one or more identified object types. The first XR system can further generate scene data by storing the object data with reference to the one or more locations in the first real-world space, and associate the scene data with at least one of the one or more spatial anchors.

In some implementations, the first XR system can identify the one or more object types from the one or more images by performing object recognition and/or computer vision techniques. In some implementations, a user of the first XR system can manually identify the one or more object types corresponding to the physical objects in the first real-world space. For example, the user can place a controller (part of or in operable communication with the first XR system) on various physical objects in the first real-world space and audibly identify the object types (e.g., “this is a door,” “this is a desk,” etc.) and/or select the object types from a list displayed on the first XR system. In some implementations, the first XR system can apply a machine learning model trained on images of known physical objects to predict the object types from the one or more images, then present the predicted object type to the user of the first XR system for confirmation and/or feedback. The first XR system can then update the model based on the feedback. I

In some implementations, process 500 can obtain previously stored scene data for the first real-world space. The previously stored scene data could have been previously captured and defined by the first XR system and/or one or more other XR systems that previously accessed the first real-world space. In such implementations, process 500 can obtain the scene data from local storage on the first XR system, from another XR system that captured and/or stored the first scene data, and/or from a central system (e.g., a remote platform computing system).

At block 504, process 500 can obtain second scene data corresponding to a second real-world space surrounding a second XR system. The second XR system can be another XR system, separate from the first XR system, launching, accessing, or requesting to access a same multiuser XR experience or application launched, accessed, or requested to be accessed by the first XR system. The second XR system (or one or more other XR systems accessing the second real-world space) can define the second scene data in a similar manner as that described above relative to the first scene data at block 502. In some implementations, process 500 can obtain the second scene data from the second XR system (or one or more other XR systems defining or otherwise storing the second scene data), and/or from a central system (e.g., a remote platform computing system). Although described herein as obtaining and using “second scene data,” it is contemplated that, in some implementations, process 500 can obtain multiple sets of scene data corresponding to multiple real-world spaces in which respective XR systems are accessing (or requesting to access) a same multiuser XR experience in which co-presence is required or desired, and perform the remainder of process 500 relative to such multiple sets of scene data.

In some implementations, process 500 can determine, based on the first and second scene data, that the first and second XR systems are co-located, such as when at least a threshold amount of the scene data matches. In some implementations, however, process 500 can determine that the first and second XR systems are co-located by any other means, such as by matching visual features of the real-world space captured by camera(s) of the first and second XR systems, by aligning spatial anchors (e.g., static frames of reference) captured by the first and second XR systems, via localization mechanisms (e.g., global positioning system (GPS), near field communication (NFC), Bluetooth, Bluetooth LE, etc.), via manual reporting by the first XR system and/or the second XR system, etc. Further details regarding determining whether XR systems are co-located, and sharing scene data therebetween, is described in U.S. patent application Ser. No. 18/069,029, entitled, “Shared Scene Co-Location for Artificial Reality Devices,” filed Dec. 20, 2022, which is hereby incorporated by reference in its entirety.

At block 506, process 500 can determine at least one area, based on the first scene data, in the first real-world space that A) meets one or more constraints and that B) matches at least a minimum set of features determined for a portion of the second real-world space based on the second scene data. The constraint(s) can include any characteristics that are needed in the first real-world space for identifying an origin point for content for the XR environment (e.g., virtual objects), without regard to characteristics of the second real-world space. In some implementations, the constraints can include, for example, physical characteristics of the first real-world space, such as size, layout, furniture or other physical objects, open floor space, etc. In some implementations, the constraints can include requirements of the XR environment and/or content for the XR environment, e.g., a particular virtual object must be rendered on a wall, on a tabletop, etc. In some implementations, the constraints can include features of virtual object(s) in the XR environment.

As noted above, process 500 can further determine the at least one area in the first real-world space that B) matches at least a minimum set of features for a portion of the second real-world space. In other words, process 500 can match characteristics of the first real-world space to characteristics of the second real-world space to determine a matched area (e.g., size, layout, furniture or other physical objects, open floor space, etc.). For example, process 500 can match areas of open floor space (and, in some implementations, match the spaces such that the open floor space is maximized), match physical objects of particular types within both spaces (e.g., tabletops or walls needed for rendering of virtual objects), etc., as indicated by the scene data. In some implementations, process 500 can alternatively or additionally determine the at least one area in the first real-world space based on existing virtual objects in the XR environment and/or virtual objects brought into the XR environment by the first XR system, the second XR system, or another XR system. For example, process 500 can determine the at least one area with respect to avatars of users already accessing the XR environment via respective XR systems and their locations in the XR environment and/or corresponding locations of their respective users in their respective real-world spaces. In some cases, the determined at least one area can correspond to open floor space or a defined physical object in the first scene data.

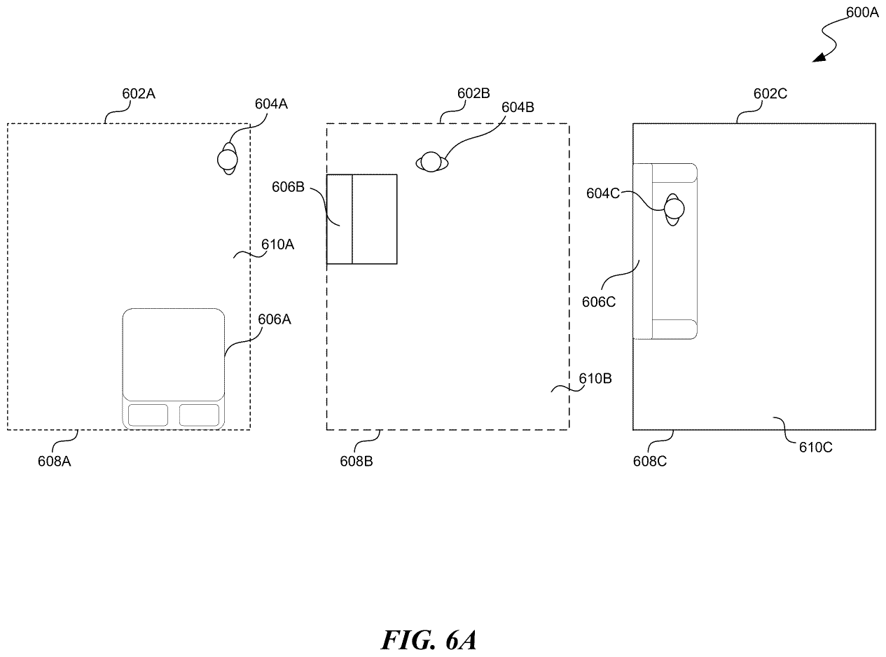

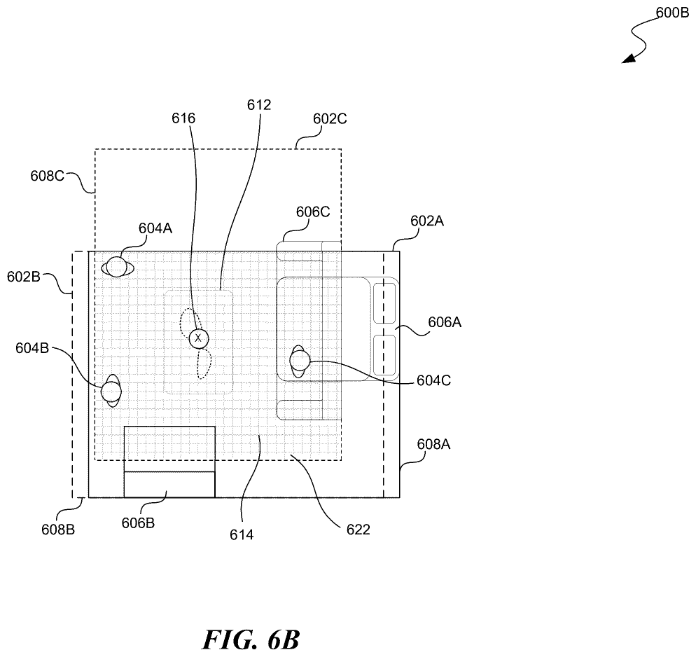

In some implementations, process 500 can construct models of the users'real-world spaces using the scene data and/or other data collected by the respective XR systems indicative of features of the respective real-world spaces. Process 500 can then construct a representation that overlaps the models of the users' real-world spaces, and determine the at least one area based on locations within the overlap that meet the defined constraints. In some implementations, process 500 can construct the representation to meet the most constraints by rotating and/or moving the models of the real-world spaces. In some implementations, process 500 can construct the representation to maximize open floor space in the at least one area. Exemplary models of real-world spaces are shown and described herein with respect to FIG. 6A. Exemplary representations that overlap models of real-world spaces are shown and described herein with respect to FIGS. 6B-6D.

At block 508, process 500 can, based at least partially on the determined at least one area, select a first origin point, for the first XR system, within the first real-world space and for the XR environment. As used herein, an “origin point” can be a point within a real-world space relative to which virtual content (e.g., virtual objects) can be positioned. For example, the origin point can be assigned an (x=0, y=0, z=0) position on a coordinate system established for the XR environment relative to which virtual objects can be positioned. In some implementations, process 500 can select the origin point at a default location within the determined at least one area of the first real-world space (e.g., at a central location). In some implementations, process 500 can select the origin point at least partially based on the constraints or features (e.g., such that a virtual object is positioned on a tabletop in the first real-world space). In some implementations, process 500 can select the first origin point at a location corresponding to a particular physical object indicated in the first scene data. In some implementations, process 500 or the second XR system can further select a second origin point for the second XR system within the second real-world space and for the XR environment, in a similar manner as that described above relative to the first origin point. When process 500 determines that the first and second XR systems are co-located, the origin points within the first and second real-world spaces can be at the same point.

At block 510, process 500 can facilitate rendering of one or more virtual objects, in the XR environment, at a same position and orientation relative to the first origin point on the first XR system as relative to the second origin point on the second XR system. Process 500 can facilitate rendering of the one or more virtual objects by displaying the virtual object(s) relative to the first origin point, providing rendering data for displaying the virtual object(s) relative to the first origin point, and/or otherwise causing or instructions the first XR system to display the virtual object(s) relative to the first origin point. For example, with the first origin point at a position corresponding to (0,0,0) on the shared coordinate system, process 500 can render a virtual object at (2 meters, 0 meters, −3 meters) relative to the first origin point. The second XR system can similarly render the virtual object at (2 meters, 0 meters, −3 meters) relative to the second origin point. It is contemplated, however, that the coordinate system used by the first and second XR systems, although aligned at their respective origin points, may have different orientations relative to the viewpoint of the respective user in the real-world space based on their position and/or orientation, and/or based on rotation of respective real-world space models in constructing the overlapping representation to determine the at least one area in the first real-world space, such as is shown in FIG. 6B.

In some implementations, process 500 can obtain input to move at least one virtual object, of the one or more rendered virtual objects, to a new position and/or orientation within the XR environment. Process 500 can then facilitate repositioning of the virtual object(s) at the new position and/or orientation at the first origin point. Similarly, the at least one virtual object can be repositioned at the new position and/or orientation relative to the second origin point (i.e., having the same position and/or orientation as relative to the first origin point), such as caused by a central computing system and/or by the second XR system. In other words, a relative distance between i) the first origin point and the new position and ii) the second origin point and the new position, is constant as rendered on both the first XR system and the second XR system.

Although described herein as positioning virtual object(s) at the same position and orientation relative to respective origin points, it is contemplated that, in some implementations, process 500 can facilitate rendering of virtual object(s) at the same position, but not necessarily with the same orientation, relative to respective origin points, such as for stereoscopic content. Further, in some implementations, it is contemplated that process 500 can facilitate rendering of one or more virtual objects that are not visible by the second XR system. For example, the multiuser XR application and/or the first user can specify one or more virtual objects that should not be shared with other co-present XR systems and/or are not part of the commonly accessed multiuser XR application (e.g., when the first user is also executing an XR home application and has virtual art hung on a real-world wall).

FIG. 6A is a conceptual diagram illustrating an example overhead view 600A of real-world space models 602A-602C for co-present users 604A-604C accessing an XR environment via respective XR systems (not shown). Real-world space models 602A-602C can be constructed based on scene data obtained for respective real-world spaces (e.g., rooms). For example, scene data corresponding to real-world space model 602A can identify bed 606A, walls 608A, and floor 610A in a bedroom in which user 604A is located. Scene data corresponding to real-world space model 602B can identify loveseat 606B, walls 608B, and floor 610B in a sitting room in which user 604B is located. Scene data corresponding to real-world space model 602C can identify couch 606C, walls 608C, and floor 610C in a living room in which user 604C is located. In some implementations, real-world space models 602A-602C can further include the locations and/or orientations of users 604A-604C within respective real-world spaces based on data collected from their respective XR systems. In this example, users 604A-604C, via their respective XR systems, have requested to access and/or are accessing a multiuser XR environment, such as a mixed reality environment in which virtual objects are overlaid onto a view of their respective real-world spaces. Although illustrated in FIG. 6A as being approximately the same size and shape, it is contemplated that the real-world spaces corresponding to real-world space models 602A-602C can be any size, shape, and/or layout, and can include any number of physical objects identified in the scene data.

FIG. 6B is a conceptual diagram illustrating an example overhead view 600B of overlapping real-world space models 602A-602C for well-positioned copresence amongst users 604A-604C accessing an XR environment based on available floor space, avatar presence, and safety. An XR copresence system described herein can rotate and/or move real-world space models 602A-602C to overlap in a manner that maximizes the usable area for the co-present users accessing the XR environment from their respective real-world spaces, such as by meeting one or more constraints or other requirements, and from that area, select origin point 616. From origin point 616, the XR copresence system can determine a shared coordinate system 622 (here represented by a three-dimensional grid) for the area common to real-world space models 602A-602C, with the origin point designated as an (x=0, y=0, z=0) point in coordinate system 622 (and in each real-world space).

For example, by rotating and/or moving real-world space models 602A-602C to maximize the amount of open floor space 614 common to each of users'604A-604C respective real-world spaces, virtual object 612 (e.g., a virtual gameboard) can be rendered in open floor space 614 and can be accessible by each of users 604A-604C. Further, the XR copresence system can ensure that none of the avatars associated with users 604A-604C (and at a corresponding position in the XR environment as users 604A-604C) are positioned outside walls 608A-608C of the respective real-world spaces of users 604A-604C. Thus, view 600B is useful for copresence in the XR environment as the open floor space 614 is maximized (e.g., has a size or percentage relative to each of the real-world spaces above a threshold), avatar presence in the XR environment is within the matching area (e.g., none of the avatars corresponding to users 604A-604C are outside of walls 608A-608C), and safety is considered (e.g., users 604A-604C will not be impeded by or collide with furniture 606A-606C while interacting with virtual object 612).

FIGS. 6C-6D are conceptual diagrams illustrating example overhead views 600C-600D of overlapping real-world space models 602A-602C that do not account for maximized floor space, avatar presence, and/or safety relative to FIG. 6B, for copresence amongst users 604A-604C accessing an XR environment. In view 600C of FIG. 6C, real-world space models 602A-602C are rotated and/or moved in a manner resulting in open floor space 618, common to all of users' 604A-604C respective real-world spaces, that is smaller than in view 600B of FIG. 6B (e.g., open floor space 618 has size or percentage, relative to each of the real-world spaces, below a threshold). Further, the avatar corresponding to user 604C is outside walls 608A of user 604A's real-world space. In addition, user 604B may collide with loveseat 606B while interacting with virtual object 612.

In view 600D of FIG. 6D, real-world space models 602A-602C are rotated and/or moved in a manner as also resulting in open floor space 620, common to all of users' 604A-604C respective real-world spaces, that is smaller than in view 600B of FIG. 6B (e.g., open floor space 620 has a size or percentage, relative to each of the real-world spaces, below a threshold). Further, the avatar corresponding to user 604B is outside walls 608A of user 604A's real-world space and walls 608C of user 604C's real-world space. In addition, user 604A may collide with walls 608A while interacting with virtual object 612.

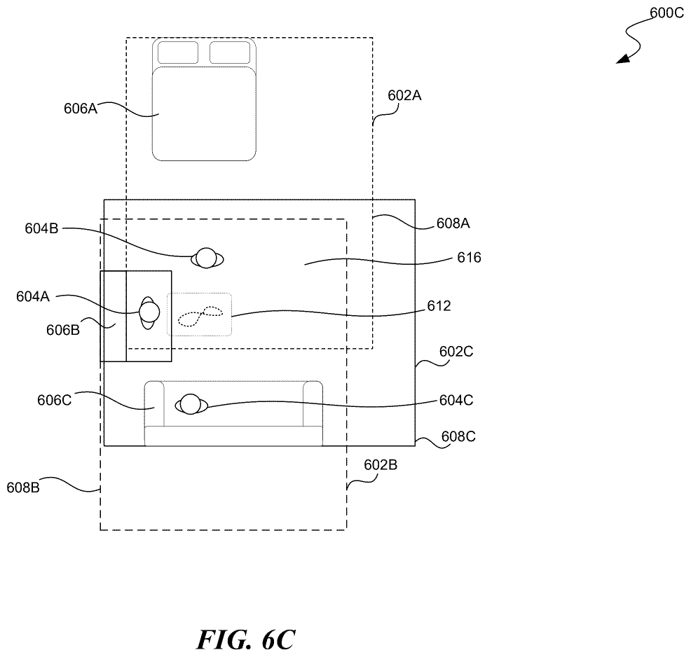

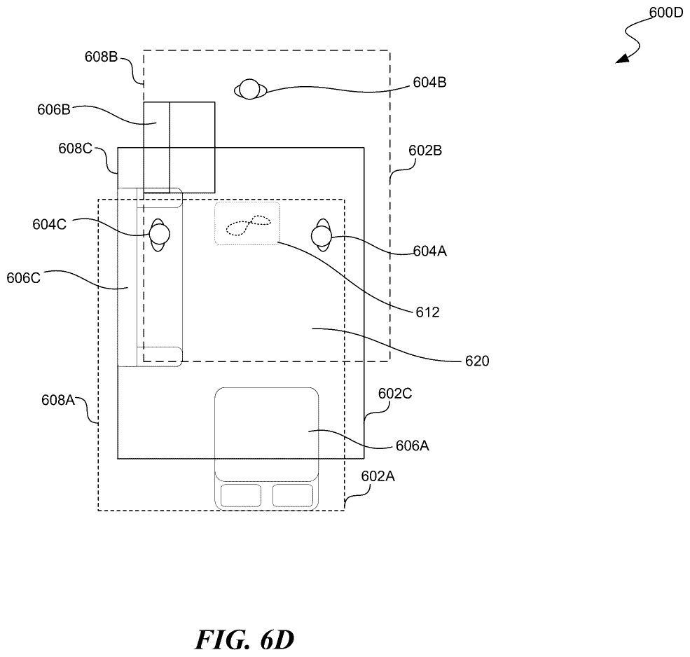

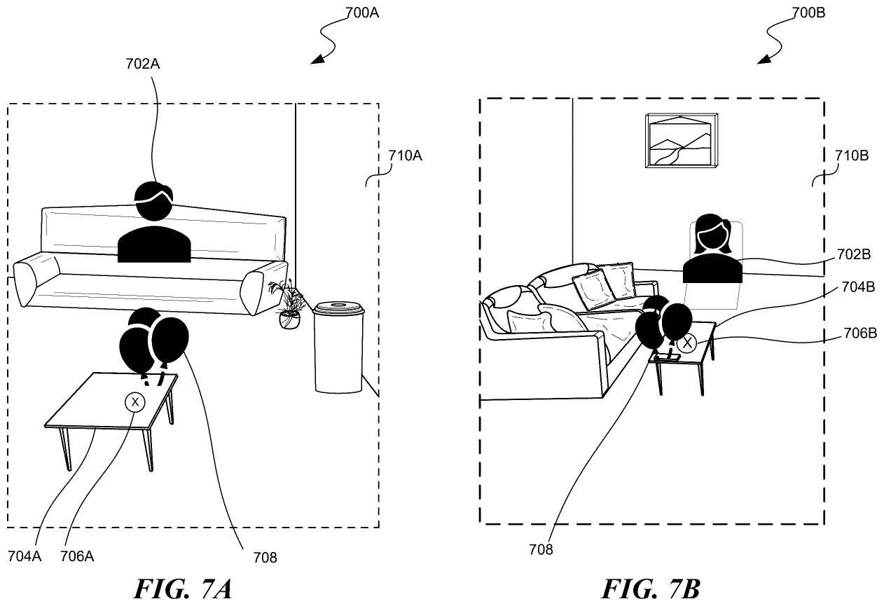

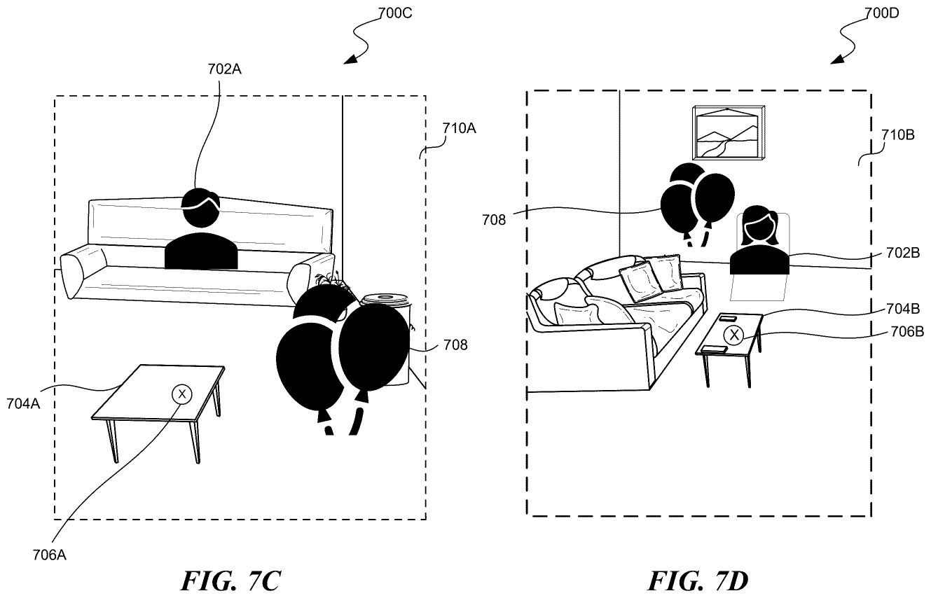

FIG. 7A is a conceptual diagram illustrating an example view 700A, from a first XR system of a first user (corresponding to avatar 702B), of an XR environment, accessed from a first real-world space 710A, including a virtual object 708 and an avatar 702A representing a second, co-present user accessing the XR environment from a second real-world space 710B. FIG. 7B is a conceptual diagram illustrating an example view 700B, from a second XR system of a second user (corresponding to avatar 702A), of an XR environment, accessed from a second real-world space 710B, including the virtual object 708 and an avatar 702B representing a first, co-present user accessing the XR environment from a first real-world space 710A. In some cases, example view 700A can be rendered on the first XR system simultaneously as example view 700B on the second XR system.

Based on particular constraints and/or features (e.g., virtual object 708 requiring rendering on a real-world table, avatars 702A-702B requiring rendering on real-world furniture, etc.), an XR copresence system can select origin point 706A for real-world space 710A and origin point 706B for real-world space 710B. Origin points 706A-706B can correspond to an (x=0, y=0, z=0) point on a coordinate system for real-world spaces 710A-710B in rendering the XR environment. In matching real-world space 710A to real-world space 710B, for example, a model of real-world space 710B can be rotated relative to a model of real-world space 710A, such as is shown and described in FIGS. 6A-6D. In example view 700A, virtual object 708A can be positioned at a (0.2 m, 0 m, 0.3 m) point relative to origin point 706A and origin point 706B, where the coordinate system is shared and common between real-world space 710A and 710B (despite the different viewpoints of the users corresponding to avatars 702A-702B). In some implementations, origin points 706A-706B can be selected such that avatars 702A-702B are positioned on real-world furniture and are opposing each other about real-world tables 704A-704B. However, it is contemplated that avatars 702A-702B can freely move about the XR environment, despite their default placement, based on movement of their corresponding users in the real-world environment and/or other input to move avatars 702A-702B (such as via one or more controllers).

FIG. 7C is a conceptual diagram illustrating an example view 700C, from a first XR system of a first user (corresponding to avatar 702B), of an XR environment, accessed by the first XR system and a second XR system of a second, co-present user (corresponding to avatar 702A), in which a virtual object 708 has been moved relative to a first origin point 706A in the XR environment. FIG. 7D is a conceptual diagram illustrating an example view 700D, from a second XR system of a second user (corresponding to avatar 702A), of an XR environment, accessed by the second XR system and a first XR system of a first, co-present user (corresponding to avatar 702B), in which the virtual object 708 has been moved relative to a second origin point 706B in the XR environment. In some cases, example view 700A can be rendered on the first XR system simultaneously as example view 700B on the second XR system.

From example view 700C, the first user (corresponding to avatar 702B) can grab virtual object 708 from table 704A and move it towards her and to the right. Similarly, as shown in example view 700D from the viewpoint of the second user (corresponding to avatar 702A), virtual object has been moved toward avatar 702B and to the right. For example, at its new position, virtual object 708 can be positioned at a (1 m, 0.5 m, −1 m) point on each coordinate system corresponding to real-world spaces 710A and 710B. In other words, virtual object 708 can move the same distance relative to origin point 706A as to origin point 706B. The distance between virtual object 708 and origin point 706A, and the distance between virtual object 708 and origin point 706B, can be the same.

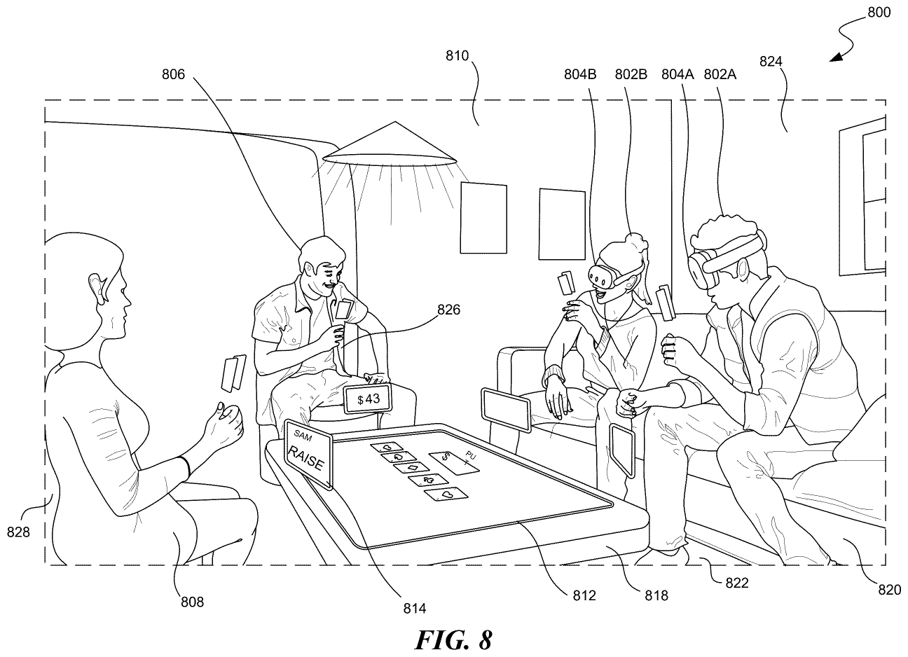

FIG. 8 is a conceptual diagram illustrating an exemplary environment 800 for XR copresence in a multiuser XR experience. Environment 800 can include a real-world environment 810. Real-world environment 810 can include user 802A wearing XR system 804A and user 802B wearing XR system 804B, as well as physical objects, such as table 818, couch 820, and chairs 826-828. User 802A and user 802B are co-located in real-world environment 810, as described further herein. Environment 800 can further include an XR environment (shown by XR systems 804A-804B, for example) having virtual objects 812, 814, etc., corresponding to an XR poker game, and avatars 806, 808 corresponding to other users, not present in real-world environment 810, that are accessing the XR poker game via respective XR systems in other real-world space(s). Thus, users 802A-802B, as well as the users corresponding to avatars 806-808, are co-present in the XR environment.

Upon launch of the XR poker game, XR system 804A, for example, can obtain scene data corresponding to real-world environment 810, such as the locations and types of objects in real-world environment 810 (e.g., table 818, couch 820, floor 822, walls 824, etc.). XR system 804A (or a central computing system, such as a platform computing system) can further obtain scene data for the real-world environments surrounding the users associated with avatars 806-808, but can decline to obtain scene data from XR system 804B upon a determination that XR systems 804A-804B are co-located.

Using the scene data, XR system 804A can determine at least one area in real-world environment 810 that A) meets one or more constraints and B) matches at least a minimum amount of features of at least a portion of the other real-world environments of the other co-present users. In this example, XR system 804A can automatically detect table 818 and empty chairs 826-828 surrounding it in real-world environment 810, and align virtual gameboard 812 and avatars 806, 808 on those directly based on a selected origin point at a central point on the top of table 818. For real-world spaces in which there isn't any furniture, the XR copresence system can determine the best possible locations for virtual gameboard 812 and avatars 806, 808, within real-world environment 810, and provide virtual chairs and/or placeholders. In some implementations, the XR copresence system can support default configurations, such as 2-6 players surrounding a rectangular tabletop (as in environment 800), 4+ players around a round table, 1-on-1 across from each other at a table, etc.

Other XR systems of the other co-present users can similarly determine respective origin points in their respective real-world environments, while co-located users 802A and 802B can share a same origin point in real-world environment 810. Each of the co-present users can view virtual objects 812, 814, etc. at a same position and orientation relative to their respective origin points. For example, user 802A can see his cards in front of his face facing him, while user 802B and the users 806-808 can similarly see his cards in front of his face facing him. Movement of virtual objects 812, 814, etc. a particular distance and direction relative to the origin point by user 802A can cause corresponding movement the same particular distance and direction relative to other co-present users' origin points.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing a shared coordinate system for extra reality copresence, the method comprising:
obtaining first scene data corresponding to a first real-world space surrounding a first extra reality system;
obtaining second scene data corresponding to a second real-world space surrounding a second extra reality system;
determining at least one area, based on the first scene data, in the first real-world space that A) meets one or more constraints and that B) matches at least a minimum set of features determined for a portion of the second real-world space based on the second scene data;
based at least partially on the determined at least one area:
selecting a first origin point, for the first extra reality system, within the first real-world space and for an extra reality environment,
wherein a second origin point, for the second extra reality system, is selected within the second real-world space and for the extra reality environment; and
facilitating rendering of one or more virtual objects, in the extra reality environment, such that the position and orientation of each virtual object, relative to the first origin point on the first extra reality system, is the same position and orientation that the virtual object has relative to the second origin point when rendered on the second extra reality system.

2. The method of claim 1,
wherein the first extra reality system and the second extra reality system are co-located such that the first real-world space and the second real-world space are a same real-world space; and
wherein, based on the first extra reality system and the second extra reality system being co-located, the first origin point and the second origin point are selected as a same location in the same real-world space.

3. The method of claim 1, further comprising:
obtaining input to move at least one virtual object, of the one or more virtual objects to a new position and/or orientation; and
repositioning the at least one virtual object at the new position and/or orientation relative to the first origin point,
wherein the at least one virtual object is repositioned at the new position and/or orientation relative to the second origin point.

4. The method of claim 1, wherein the first origin point and the second origin point are assigned a (x=0, y=0, z=0) position on a coordinate system established for the extra reality environment relative to which the one or more virtual objects are rendered.

5. The method of claim 1, wherein the determined at least one area corresponds to A) open floor space or B) a defined physical object, in the first scene data and the second scene data, according to the one or more constraints.

6. The method of claim 1, wherein the at least the minimum set of features include one or more matched physical characteristics between the first real-world space and the second real-world space.

7. The method of claim 1, wherein the determining the at least one area includes:
generating a first model of the first real-world space using the first scene data;
obtaining a second model of the second real-world space generated using the second scene data; and
matching an area, of the at least one area of the first model, to the second model.

8. The method of claim 7, wherein the matching the area includes rotating and/or moving the first model and/or the second model in such a manner that maximizes open floor space in the area.

9. The method of claim 1, wherein the one or more constraints include at least one of:
one or more features of at least one virtual object of the one or more virtual objects,
one or more rendering requirements of the at least one virtual object of the one or more virtual objects,
one or more avatars corresponding to one or more users of one or more other extra reality systems accessing the extra reality environment,
one or more locations of the one or more avatars relative to respective one or more origin points for the one or more other extra reality systems in the extra reality environment, or
any combination thereof.

10. The method of claim 1, wherein the at least the minimum set of features include one or more of:
size of the first real-world space and/or the second real-world space,
layout of the first real-world space and/or the second real-world space, or
any combination thereof.

11. The method of claim 1, further comprising:
receiving input, from the first extra reality system, to move a virtual object, of the one or more virtual objects, to an updated position relative to the first origin point in the extra reality environment; and
facilitating movement of the virtual object to the updated position relative to the first origin point on the first extra reality system;
wherein the virtual object is moved to the updated position relative to the second origin point on the second extra reality system, and
wherein a relative distance between A) the first origin point and the updated position and B) the second origin point and the updated position, is constant as rendered on both the first extra reality system and the second extra reality system.

12. A computer-readable storage medium storing instructions, for providing a shared coordinate system for extra reality (XR) copresence, the instructions, when executed by a computing system, cause the computing system to:
obtain scene data corresponding to multiple real-world spaces surrounding multiple XR systems, including a first real-world space surrounding a first XR system;
determine at least one area, based on the scene data, in the first real-world space that A) meets one or more constraints and that B) matches at least a minimum set of features determined for portions of the multiple real-world spaces;
based at least partially on the determined at least one area:
select a first origin point, for the first XR system, within the first real-world space and for an XR environment,
wherein at least one other origin point, for at least one other XR system, of the multiple XR systems, is selected within at least one other real-world space, of the multiple real-world spaces, and for the XR environment; and
facilitate rendering of one or more virtual objects, in the XR environment, such that the position and orientation of each virtual object, relative to the first origin point on the first XR system, is the same position and orientation that the virtual object has relative to the at least one other origin point when rendered on the at least one other XR system.

13. The computer-readable storage medium of claim 12,
wherein the multiple XR systems are co-located such that the multiple real-world spaces are a same real-world space; and
wherein, based on the multiple XR systems being co-located, the first origin point and the at least one other origin point are selected as a same location in the same real-world space.

14. The computer-readable storage medium of claim 12, wherein the instructions, when executed by the computing system, further cause the computing system to:
obtain input to move at least one virtual object, of the one or more virtual objects to a new position and/or orientation; and
repositioning the at least one virtual object at the new position and/or orientation relative to the first origin point,
wherein the at least one virtual object is repositioned at the new position and/or orientation relative to the at least one other origin point.

15. The computer-readable storage medium of claim 12, wherein the determined at least one area corresponds to A) open floor space or B) a defined physical object, in the scene data, according to the one or more constraints.

16. The computer-readable storage medium of claim 12, wherein the at least the minimum set of features include one or more matched physical characteristics between the multiple real-world spaces.

17. A computing system for providing a shared coordinate system for extra reality (XR) copresence, the computing system comprising:
one or more processors; and
one or more memories storing instructions that, when executed by the one or more processors, cause the computing system to:
obtain scene data corresponding to multiple real-world spaces surrounding multiple XR systems, including a first real-world space surrounding a first XR system;
determine at least one area, based on the scene data, in the first real-world space that A) meets one or more constraints and that B) matches at least a minimum set of features determined for portions of the multiple real-world spaces;
based at least partially on the determined at least one area:
select a first origin point, for the first XR system, within the first real-world space and for an XR environment,
wherein at least one other origin point, for at least one other XR system, of the multiple XR systems, is selected within at least one other real-world space, of the multiple real-world spaces, and for the XR environment; and
facilitate rendering of one or more virtual objects, in the XR environment, such that the position and orientation of each virtual object, relative to the first origin point on the first XR system, is the same position and orientation that the virtual object has relative to the at least one other origin point when rendered on the at least one other XR system.

18. The computing system of claim 17, wherein the determining the at least one area includes:
generating a first model of the first real-world space using first scene data, of the obtained scene data, corresponding to the first-real-world space;
obtaining a second model of a second real-world space, of the multiple real-world spaces, generated using second scene data, of the obtained scene data, corresponding to the second real-world space; and
matching an area, of the at least one area in the first model, to the second model.

19. The computing system of claim 18, wherein the matching the area includes rotating and/or moving the first model and/or the second model in a manner that maximizes open floor space in the area.

20. The computing system of claim 17, wherein the one or more constraints include at least one of:
one or more features of at least one virtual object of the one or more virtual objects,
one or more rendering requirements of the at least one virtual object of the one or more virtual objects,
one or more avatars corresponding to one or more users of one or more other extra reality systems accessing the XR environment,
one or more locations of the one or more avatars relative to respective one or more origin points for the one or more other extra reality systems in the XR environment, or
any combination thereof.
